(19) United States
(12) Patent Application Publication
(10) Pub. No.: US 2019/0325773 A1
(43) Pub. Date: Oct. 24, 2019

(54) SYSTEM AND METHOD OF PROVIDING CUSTOMIZED LEARNING CONTENTS

(71) Applicant: ST UNITAS CO., LTD., Seoul (KR)

(72) Inventors: Hwe Chul Cho, Seoul (KR); Bon Jun Koo, Seoul (KR); Joo Young Yoon, Seoul (KR); Sang Pil Jun, Seoul (KR)

(21) Appl. No.: 16/384,915

(22) Filed: Apr. 15, 2019

(30) Foreign Application Priority Data
Apr. 23, 2018 (KR) 10-2018-0046853

(51) Int. Cl. G09B 7/04; G09B 5/12; G06N 3/08

(52) U.S. Cl. CPC G09B 7/04; G06N 3/08; G09B 5/12

(57) ABSTRACT

A system of providing learning contents includes: a level measuring module providing a plurality of test questions including a plurality of types to a user and receiving a test result; a database storing the plurality of test questions including the plurality of types, provided to the user, a test result for the user, test results for other users; and a score predicting module calculating a correct answer percentage of the user for each of the plurality of types through the test result and substituting the correct answer percentage into actual examination data to predict an obtainable score of the user in an actual examination.

### CROSS-REFERENCE TO RELATED APPLICATION

This application is based on and claims the benefit of priority to Korean Patent Application No. 10-2018-0046853, filed on Apr. 23, 2018 in the Korean Intellectual Property Office, the disclosure of which is incorporated by reference herein in its entirety.

### TECHNICAL FIELD

The present disclosure relates to a system and method of providing customized learning contents.

### BACKGROUND

Currently, in an education system in Korea, learning has been generally conducted collectively on many students off-line through a school, an academy, or the like, or on-line through the Internet lecture, and some students have performed individual learning through private tutoring.

However, since lessons through the school or the academy, a moving picture lecture, and the like, are unilaterally and uniformly provided from a side providing an education service to all the students depending on a predetermined curriculum and lecture time, the students only passively follow the corresponding lessons. As described above, according to a uniform curriculum, it is difficult to reflect learning habits or characteristics of individual students, and a deviation in an academic achievement effect between the students depending on learning levels of the students is gradually increased over time, such that the individual students waste a lot of time and money.

In addition, in a case of the private tutoring, private tutors may conduct lessons depending on learning levels and characteristics of students, but capacities of the private tutors are very different from each other, and economic loads of the students are increased due to a tuition fee higher than that of the lesson of the school or the academy.

Therefore, in order to improve learning efficiency of the students beyond the curriculum uniformly provided to many students in the related art, it has been demanded to accurately grasp study habits, learning characteristics, academic performances, and the like, of the individual students and provide a customized education optimized for the individual students.

### SUMMARY

An aspect of the present disclosure provides a system and method of providing customized learning contents capable of maximizing a learning effect by accurately diagnosing a learning level of a user and providing learning contents optimized for each user.

According to an exemplary embodiment of the present disclosure, a system of providing learning contents includes: a level measuring module providing a plurality of test questions including a plurality of types to a user and receiving a test result; a database storing the plurality of test questions including the plurality of types, provided to the user, a test result for the user, test results for other users; and a score predicting module calculating a correct answer percentage of the user for each of the plurality of types through the test result and substituting the correct answer percentage into actual examination data to predict an obtainable score of the user in an actual examination.

According to another exemplary embodiment of the present disclosure, a method of providing learning contents using a system including a database storing a plurality of test questions including a plurality of types, provided to a user, a test result for the user, and test results for other users includes: providing the plurality of test questions including the plurality of types to the user; receiving the test result; calculating a correct answer percentage of the user for each of the plurality of types through the test result; substituting the correct answer percentage of the user for each type for the questions into actual examination data; and predicting an obtainable score of the user in an actual examination.

According to still another exemplary embodiment of the present disclosure, a learning application stored in a user terminal executes the following processes: a process of providing a plurality of test questions including a plurality of types to a user; a process of transmitting a test result to a server when the user submits answers to the plurality of test questions including the plurality of types; and a process of receiving and displaying an obtainable score of the user in an actual examination, calculated by the server.

### BRIEF DESCRIPTION OF THE DRAWINGS

FIG. 1 is a block diagram illustrating a system of providing customized learning contents according to an exemplary embodiment of the present disclosure.

FIG. 2 illustrates a method of predicting an obtainable score of a user by a score predicting module in the system of providing customized learning contents according to an exemplary embodiment of the present disclosure.

FIGS. 3A and 3B are views illustrating that a tag registering module of the system of providing customized learning contents according to an exemplary embodiment of the present disclosure provides recommendation tags for each question.

FIG. 4 is a view illustrating that a user level measuring module of the system of providing customized learning contents according to an exemplary embodiment of the present disclosure determines a learning progress situation of the user for each tag through a skip-gram.

FIG. 5 is a view illustrating an example in which a content recommending module of the system of providing customized learning contents according to an exemplary embodiment of the present disclosure determines difficulty levels of questions through item characteristic curves generated using past test questions.

FIG. 6 is a view illustrating a process in which the content recommending module of the system of providing customized learning contents according to an exemplary embodiment of the present disclosure recommends questions using the item characteristic curves.

FIG. 7 is a flow chart illustrating a method of providing customized learning contents according to an exemplary embodiment of the present disclosure.

FIG. 8 is a view illustrating that the system of providing customized learning contents according to an exemplary embodiment of the present disclosure and user terminals are connected to each other through a network.

FIG. 9 is a view illustrating a hardware configuration of a user terminal including a learning content application according to an exemplary embodiment of the present disclosure.

FIG. 10 is a flow chart illustrating a method of performing learning by communication between the system of providing customized learning contents according to an exemplary embodiment of the present disclosure and the user terminal.

### DETAILED DESCRIPTION

Hereinafter, various exemplary embodiments of the present disclosure will be described in detail with reference to the accompanying drawings. Herein, the same components will be denoted by the same reference numerals throughout the drawings, and an overlapping description for the same components will be omitted.

Specific structural or functional descriptions will be provided only in order to describe various exemplary embodiments of the present disclosure disclosed herein. Therefore, exemplary embodiments of the present disclosure may be implemented in various forms, and the present disclosure is not to be interpreted as being limited to exemplary embodiments described herein.

Expressions “first”, “second”, and the like, used in various exemplary embodiments may indicate various components regardless of a sequence and/or importance of these components, and do not limit the corresponding components. For example, the ‘first’ component may be named the ‘second’ component, and vice versa, without departing from the scope of the present disclosure.

Terms used herein may be used only in order to describe specific exemplary embodiments rather than restricting the scope of other exemplary embodiments. Singular forms may include plural forms unless the context clearly indicates otherwise.

All terms used herein including technical and scientific terms have the same meanings as those that are generally understood by those skilled in the art to which the present disclosure pertains. Terms generally used and defined by a dictionary may be interpreted as having the same meanings as meanings within a context of the related art, and are not interpreted as having ideal or excessively formal meanings unless clearly defined otherwise herein. In some cases, terms may not be interpreted to exclude exemplary embodiments of the present disclosure even though they are defined herein.

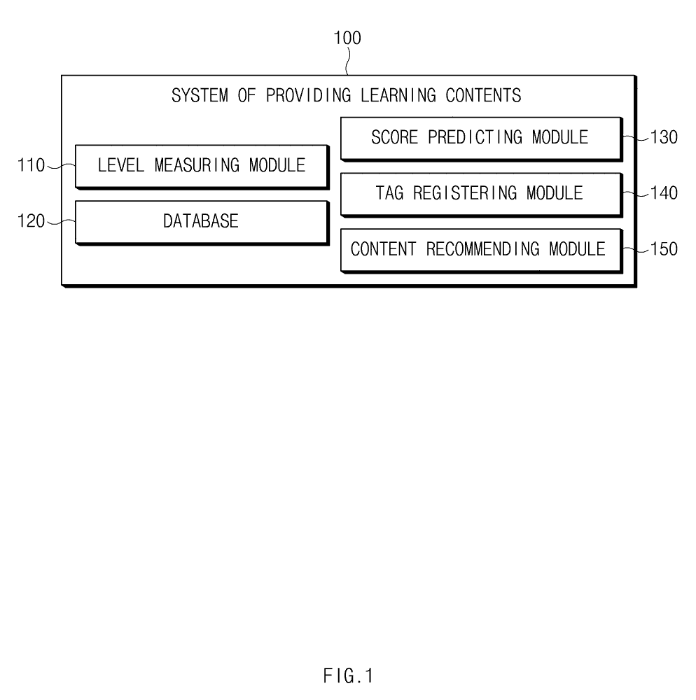

FIG. 1 is a block diagram illustrating a system of providing customized learning contents according to an exemplary embodiment of the present disclosure.

Referring to FIG. 1, the system 100 of providing customized learning contents according to an exemplary embodiment of the present disclosure may include a level measuring module 110, a database 120, a score predicting module 130, a tag registering module 140, and a content recommending module 150.

The level measuring module 110 may provide a plurality of test questions including a plurality of types to a user, and receive a test result. In this case, it is preferable that the level measuring module 110 provides the plurality of test questions including types as various as possible to the user to allow a learning situation of the user for each type to be accurately diagnosed.

In this case, the test questions provided by the level measuring module 110 may be configured to be provided to the user by allowing the user to directly select an examination (for example, a national civil service examination, an official English examination such as TOEIC, TOEFL, or the like, a national license examination, an admission examination for a medical college, a dental college, or a pharmaceutical college, or the like) of which prediction of a score is desired by the user.

Particularly, the test questions provided through the level measuring module 110 may be configured depending on a combination of tags held for each kind of each examination to improve reliability of score prediction for an actual examination. In addition, even though the test questions are not configured to include all tags included in each examination, score prediction for an actual examination may be possible using a correlation between whether or not an answer for a specific tag included in the test questions is a correct answer and a tag (for example, a tag that is not included in the test questions) different from the corresponding tag.

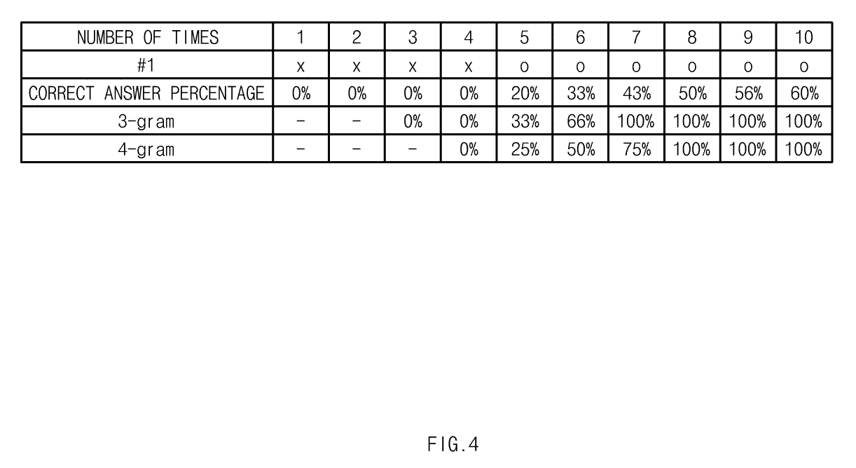

After a test is performed by the user, the user may perform learning related to an examination on which the test is performed on the basis of the test result. In this case, the level measuring module 110 may grasp a correct answer percentage of the user for a predetermined number of times for a plurality of questions including a specific type using a skip-gram to update and determine a learning progress situation of the user for each question type. Details thereof will be described below with reference to FIG. 4.

The database 120 may store the plurality of test questions including the plurality of types described above, provided to the user, the test result for the user, test results for other users.

In addition, questions of which registration of tags are completed by a tag registering module 140 to be described below may be stored in the database 120. Only a single tag of each of the questions may be registered or a plurality of tags of each of the questions may be registered. In addition, the database 120 may provide a test including questions of which tags are registered to the user through the level measuring module 110 and store a test result to allow the test result to be utilized for the score predicting module 130 and the content recommending module 150 to predict an obtainable score of the user and provide a content optimized for each user.

In addition, past test questions of various examinations, a correct answer percentage or a score distribution for each of the corresponding past test questions, a result obtained by actually solving the past test questions by members, and the like, may be additionally stored in the database 120. Here, the various examinations may include, for example, a national civil service examination, an official English examination such as TOEIC, TOEFL, or the like, a national license examination, an admission examination for a medical college, a dental college, or a pharmaceutical college, and the like.

The score predicting module 130 may calculate a correct answer percentage of the user for each type for the plurality of questions described above through the test result of the user, and substitute the correct answer percentage into actual examination data to predict an obtainable score of the user in an actual examination. In this case, the score predicting module may automatically predict the obtainable score of the user through a deep learning technique.

That is, the score predicting module 130 may calculate a score predicted to be obtained by the user in an examination selected by the user, using test results (for example, including a correct answer percentage for each type for the questions) for a plurality of users stored in the database 120. Here, the actual examination data mean all data derivable through the actual examination, such as obtained scores, a standard score distribution, a correct answer percentage for each question type, and the like, of applicants of the actual examination.

In detail, for example, a correct answer percentage of a specific user for each question type for a specific examination is calculated through the test questions provided by the level measuring module 110, and a calculation result is added up to correct answer percentages of other users for each question type, such that a correct answer percentage of the corresponding user for all the types is calculated. In addition, it is predicted whether an answer to each question at a current point in time of the user for the actual examination is correct or wrong using the calculated correct answer percentage for each type, and an original score obtainable at the corresponding point in time is calculated. Further, the calculated obtainable score may be substituted into the actual examination data to calculate a standard score in the corresponding examination. In addition, the score predicting module 130 may predict obtainable scores of the user for each of N times past test questions, calculate an average of the obtainable scores, and provide the calculated average to the user.

As described above, the user may predict the obtainable score and the standard score in the actual examination only by solving the test questions on the system.

The tag registering module 140 may register a tag for each question depending on an attribute of the question input to the system 100 of providing customized learning contents. Here, a process of assigning the tag for each type of the questions may be learned in advance in the tag registering module 140 by an expert, such that when an administrator of the system inputs the question, the tag for each question may be registered depending on the type of the questions. In this case, the tag registering module 140 may learn a tag registering process for each question in advance in through, for example, deep learning.

In addition, the tag registering module 140 may register tags for past test questions as well as questions directly generated by the administrator of the system or questions extracted from an existing item pool.

The content recommending module 150 may provide questions appropriate for a learning level of the user using the test result. That is, the content recommending module 150 may grasp in which type of question the user is weak through a result obtained by solving the previous test, and extract and provide questions appropriate for a learning level of each user.

In addition, the content recommending module 150 may provide the questions appropriate for the learning level of the user in a manner of selecting the questions appropriate for the learning level of the user among the past test questions stored in the database 120. Particularly, the content recommending module 150 may provide expected questions on the basis of one or more of similarity to passages of the past test questions, similarity of a keyword and a type of each of the past test questions, and whether or not answers coincide with correct answers of the past test questions.

In addition, the content recommending module 150 may provide questions in which the user is weak using the test result of the user. In this case, the questions in which each user is weak may be extracted from a plurality of questions including a type for which a correct answer percentage of the user is a preset reference or less. Particularly, the content recommending module 150 may extract tags for which the correct answer percentage of the user is a predetermined level or less to select and provide types of questions in which the user is weak.

The content recommending module 150 may provide questions including types for which a correct answer percentage calculated by the score predicting module 130 is in a preset range of the correct answer percentage. For example, the content recommending module 150 may select and provide only questions of a region for which a correct answer percentage is a preset minimum correct answer percentage or more among questions of a region for which a correct answer percentage of the user is a predetermined level or less to prevent a learning motivation of the user from being decreased due to continuously solving difficult questions.

In addition, the content recommending module 150 may determine frequencies at which specific types are issued and arrange and provide the questions appropriate for the learning level of the user in a descending order of the frequencies, in providing the questions appropriate for the learning level of the user. For example, the content recommending module 150 may calculate each of frequencies at which questions including Tag A, Tag B, and Tag C are issued, and provide recommending questions to the user in an order of questions including Tag A, Tag C, and Tag B in the case in which the frequencies are high in an order of Tag A, Tag C, and Tag B.

Hereinafter, a specific function of the system 100 of providing customized learning contents described above will be described in more detail.

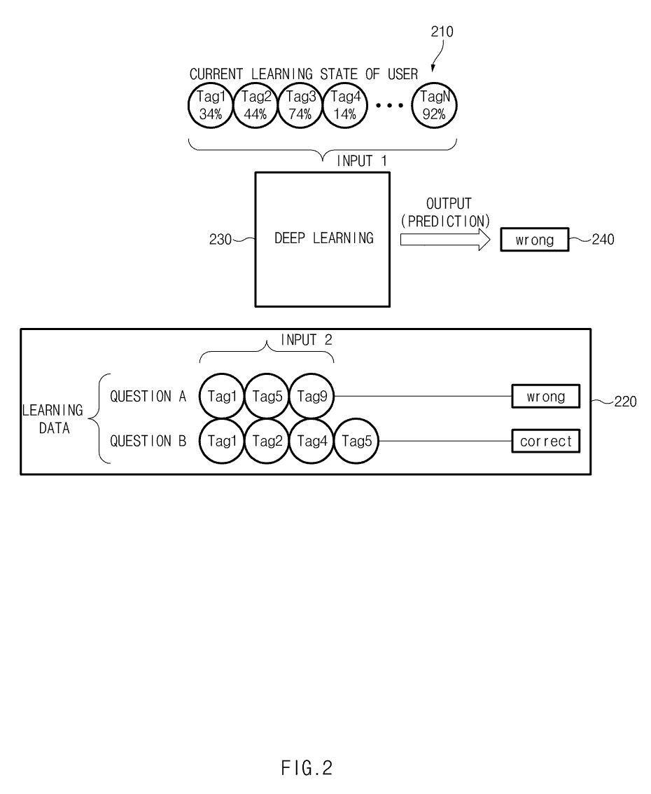

FIG. 2 illustrates a method of predicting an obtainable score of a user by a score predicting module in the system of providing customized learning contents according to an exemplary embodiment of the present disclosure.

Referring to FIG. 2, the score predicting module 130 of the system 100 of providing customized learning contents may determine whether answers of the user to questions are correct or wrong (240) in a manner of deep learning 230 using a current learning state 210 of the user from the database 120 and a learning data 220 on a test result obtained through the level measuring module to predict an obtainable score in the corresponding examination.

Particularly, an example of using tags as a manner of indicating types of questions is illustrated in an exemplary embodiment of FIG. 2, but the present disclosure is not limited thereto, and various methods of indicating types of the corresponding questions may be used.

The current learning state 210 of the user is a data indicating a current learning level of the user that uses the system 100 of providing customized learning contents according to an exemplary embodiment of the present disclosure. That is, the current learning state 210 of the user means that a correct answer percentage for each type of the questions is calculated on the basis of the test result, or the like, performed in the past by the user. The respective correct answer percentages for Tag 1 to Tag N are calculated and illustrated by way of example in FIG. 2, but the present disclosure is not limited thereto, and correct answer percentages for a combination of a plurality of tags may be illustrated.

The learning data 220 may indicate a result of a test performed by the user through the level measuring module 110 of the system of providing customized learning contents according to an exemplary embodiment of the present disclosure. In an example of FIG. 2, one or more tags are assigned to each question (a, b, and the like). In detail, Tags 1, 5, and 9 are assigned to Question a, and Tags 1, 2, 4, and 5 are assigned to Question b. Particularly, it is preferable that tags assigned to each question in a test provided to the user are configured to include all types expected to be issued in an actual examination, if possible. As described above, the current learning state 210 of the user and the learning data 220 may be stored in the database.

The score predicting module 130 may add up the current learning state 210 (input 1) of the user and the learning data 220 (input 2) to calculate a final learning level of the user. In this case, the learning level of the user may be calculated through a technique of the deep learning 230. Particularly, the learning level of the user may be determined by calculating the correct answer percentages for each tag or for the combination of the plurality of tags by a calculation equation input to the system.

Meanwhile, at the time of predicting the score, data on an actual past test examination or another mock examination may be additionally input. For example, the tags as illustrated in FIG. 2 may be assigned to the respective questions of the actual past test examination or another mock examination. Therefore, prediction for whether answers to each question are corrected or wrong (or correct answer percentages for each question) becomes possible by applying the data on the correct answer percentages for each tag that are previously calculated to the actual past test examination or the mock examination.

That is, according to the score predicting module 130, the corresponding user may predict whether or answers to each question of the actual past test examination or the mock examination are corrected or wrong (or correct answer percentages for each question) using the correct answer percentages for each tag of the user calculated in a deep learning manner, and may finally predict an obtainable score of the user in the corresponding examination.

The score predicting module 130 may apply the current learning state 210 of the user to a plurality of past test examinations and/or mock examinations to predict scores for each of the plurality of past test examinations and/or mock examinations, and may utilize an average of the predicted scores as a final predicted score.

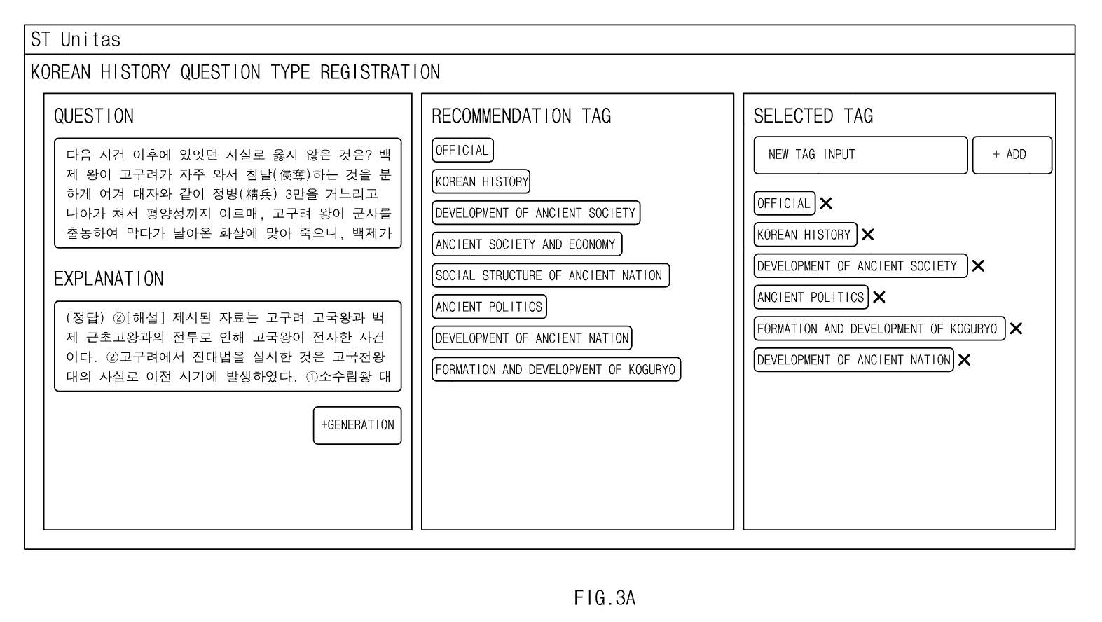

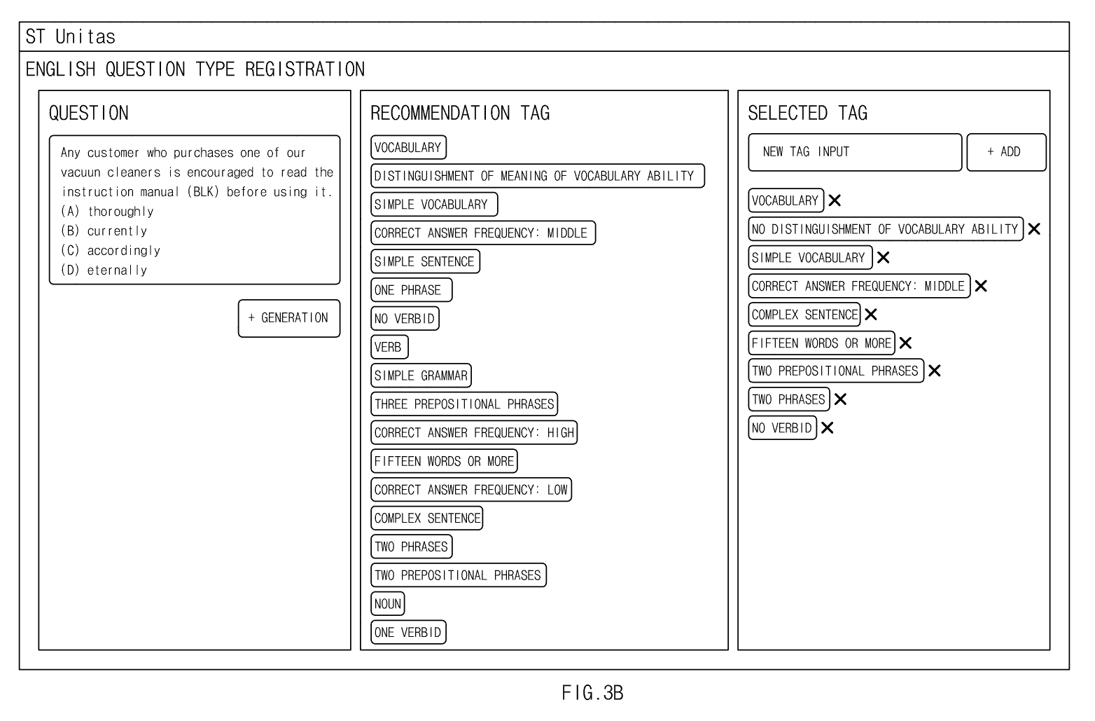

FIGS. 3A and 3B are views illustrating that a tag registering module of the system of providing customized learning contents according to an exemplary embodiment of the present disclosure provides recommendation tags for each question.

Referring to FIGS. 3A and 3B, the tag registering module 140 may provide recommendation tags related to attributes of questions input to the system, and allow the administrator of the system to select and register desired tags of the recommendation tags. In detail, the tag registering module 140 may be configured to learn a process of determining types of questions through the respective questions, keywords of explanations, and the like, in advance by an expert and automatically determine the types when the administrator of the system inputs the questions, thereby recommending or directly registering the tags.

For example, the tag registering module 140 of FIG. 3A may extract and display tags such as “Official”, “Korean History”, “Development of Ancient Society”, “Ancient Society and Economy”, “Social Structure of Ancient Nation”, “Ancient Politics”, “Development of Ancient Nation”, and “Formation and Development of Koguryo” through keywords of a Korean history question input by the administrator of the system. In this case, as illustrated in FIG. 3A, the administrator of the system selects and registers only “Official”, “Korean History”, “Development of Ancient Society”, “Ancient Politics”, and “Formation and Development of Koguryo” among the recommended tags.

In addition, the tag registering module 140 of FIG. 3B grasps types of an English question input by the administrator of the system to extract and display tags such as “Vocabulary”, “Correct Answer Frequency: Middle”, “Verb”, “Fifteen Words or More”, “Two Prepositional Phrases”, “Complex Sentence”, “No Verbid”, and the like. In this case, in the same manner as that in FIG. 3A, the administrator of the system selects and registers some tags such as “Vocabulary”, “Correct Answer Frequency: Middle”, “Complex Sentence”, “No Verbid”, and the like, among the recommended tags.

FIG. 4 is a view illustrating that a user level measuring module of the system of providing customized learning contents according to an exemplary embodiment of the present disclosure determines a learning progress situation of the user for each type through a skip-gram.

Referring to FIG. 4, in the case in which there are test results of plural numbers of times for the user, the score predicting module 130 may provide a correct answer percentage of the user for a predetermined number of times for a plurality of questions including a specific type using a skip-gram to update the learning progress situation of the user for each type to the latest information.

For example, in FIG. 4, when ‘#1’ is a specific type of tag, an average correct answer percentage of a total of ten numbers of times for ‘#1’ and correct answer percentages for 3-gram and 4-gram are illustrated. In this case, 3-gram or 4-gram indicate correct answer percentages of recent three numbers of times or four numbers of times.

In detail, in the case in which it is determined to what level the user knows about Tag ‘#1’, when an average correct answer percentage is calculated on the basis of all of the results obtained by solving a question including Tag ‘#1’ ten times, the average correct answer percentage corresponds to 60%, but when the number of results obtained by recently solving the question is designated to N as in 3-gram or 4-gram and correct answer percentages are estimated, a learning level of the user for the corresponding tag may be more accurately determined on the basis of only the latest results.

That is, in the case in which learning progresses over time, a correct answer percentage for a recent number of times is more meaningful than an average correct answer percentage for all numbers of times. Therefore, the current learning level of the user may be updated to the latest information by applying a skip-gram algorithm to calculate a correct answer percentage and comparing the correct answer percentage for the corresponding type with the average correct answer percentage for the previous numbers of times.

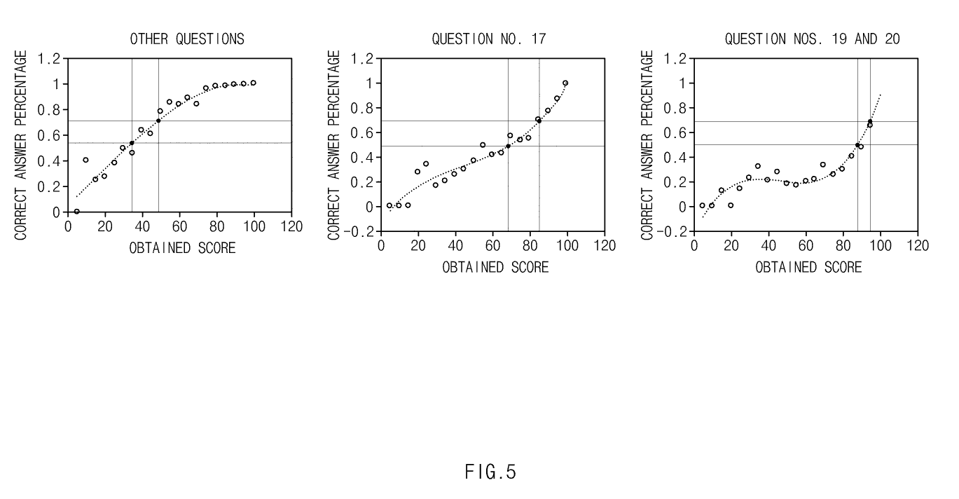

FIG. 5 is a view illustrating an example in which a content recommending module of the system of providing customized learning contents according to an exemplary embodiment of the present disclosure determines difficulty levels of questions through item characteristic curves generated using past test questions.

Referring to FIG. 5, the content recommending module 150 may extract a sample group having predicted scores following a normal distribution of past test questions among scores for each user predicted by the score predicting module 130, and objectively determines difficulty levels of the questions through item characteristic curves generated by testing the same questions as the past test questions in the sample group to refer to the difficulty levels in providing optimized questions to the user later.

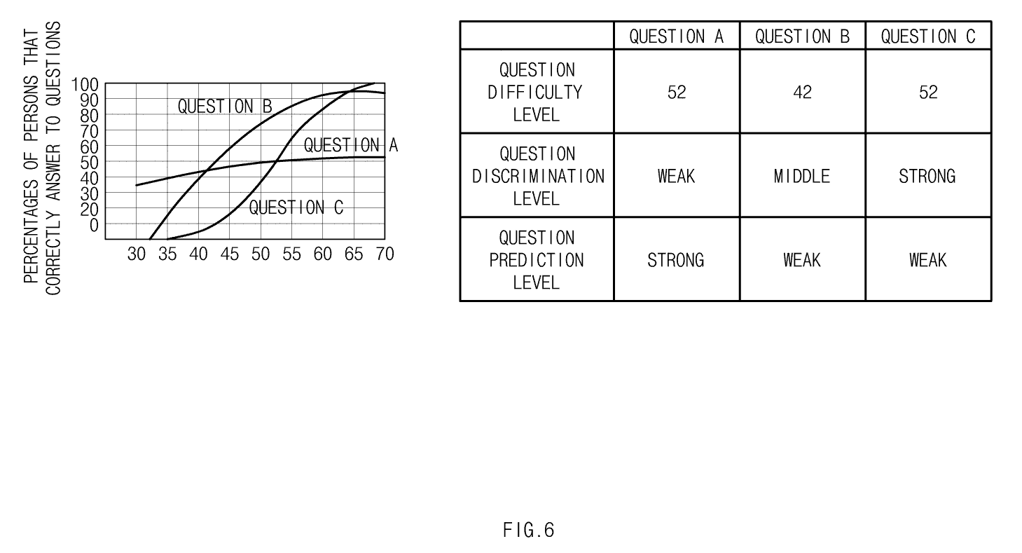

Here, the item characteristic curve, which is a curve indicating a correct answer percentage depending on a capability level of a testee for a specific question, generally indicates a difficulty level and a discrimination level of the corresponding question. The item characteristic curve will be described below in detail with reference to FIG. 6. Since the past test examination and the system of providing customized learning contents according to an exemplary embodiment of the present disclosure have different populations, difficulty levels based on the correct answer percentages may be measured to be different from each other even though questions are the same as each other. That is, a question easy on the basis of the past test examination may appear to be difficult for a user group of the system of providing customized learning contents according to the present disclosure to solve.

In order to solve such a problem, in the system of providing customized learning contents according to an exemplary embodiment of the present disclosure, the questions may be objectively evaluated by generating a sample following the normal distribution through prediction of an obtainable score of the past test examination. In detail, a population is generated by predicting obtainable scores of each user for the past test questions. In addition, a sample group having obtainable scores following the normal distribution of the past test examination is extracted from the population. Next, the item characteristic curve is generated by allowing the sample group to solve the same questions. The question data generated as described above are applied to an algorithm recommending the questions to the user.

In an example of FIG. 5, results obtained by applying Korean history of a Grade 9 central government official examination in 2017 to the algorithm described above are illustrated. Here, (b) and (c) illustrate item characteristic curves for three questions determining success or failure, and (a) illustrates an item characteristic curve for other questions. Referring to FIG. 5, when the item characteristic curves of (b) and (c) for the three questions determining the success or failure are compared with the item characteristic curve of (a) for other questions, it may be appreciated that a point at which a correct answer percentage for each score is 50% appears at the right of graphs of the item characteristic curves of (b) and (c), and gradients of the item characteristic curves of (b) and (c) are greater than that of the item characteristic curve of (a). That is, in the system of providing customized learning contents according to an exemplary embodiment of the present disclosure, difficulty levels may be determined by adding an obtainable score (a value of an x axis in the graph of FIG. 5) at the point at which the correct answer percentage is 50% and a gradient at that point to each other.

That is, the difficulty levels for each question are determined through the following Equation:

Difficulty Level=obtainable score at point at which correct answer percentage is 50%+gradient at that point

FIG. 6 is a view illustrating a process in which the content recommending module of the system of providing customized learning contents according to an exemplary embodiment of the present disclosure recommends questions using the item characteristic curves.

Referring to FIG. 6, a graph illustrates an example of predicting a score currently obtainable by the user and extracting a question list corresponding to tags in which the user is weak through the system of providing customized learning contents according to an exemplary embodiment of the present disclosure. Here, an x axis of the graph indicates a value of a capability level of a testee, that is, an obtainable value, and a y axis of the graph indicates a percentage of persons that correctly answer to the corresponding questions. Referring to the item characteristic curves for each question of FIG. 6, question difficulty levels, question discrimination levels, and question prediction levels of the respective questions may be grasped, and are illustrated in a table of FIG. 6.

Here, the question difficulty levels, which are difficulty levels of the corresponding questions, are indices indicating percentages of testees that correctly answer among answering testees. In this case, the question difficulty levels may be calculated as values of capability levels corresponding to a point at which percentages of persons that correctly answer to questions are 50% on item characteristic curves of individual questions. That is, as illustrated in the table in an example of FIG. 6, it may be appreciated that a difficulty level of Question A is 52, a difficulty level of Question B is 42, and a difficulty level of Question C is 52.

In addition, the question discrimination levels correspond to indices indicating levels at which individual questions discriminate testees from each other depending on capabilities. In this case, the question discrimination levels may be calculated through gradients of the item character curves at a point corresponding to the question difficulty level, that is, the point at which the percentage of the persons that correctly answer to the questions is 50% on the item characteristic curves of the individual questions. That is, in the example of FIG. 6, since the gradients at the corresponding point are large in an order of Question C, Question B, and Question A, a discrimination level of Question

A is represented as “weak”, a discrimination level of Question B is represented as “middle”, and a discrimination level of Question C is represented as “strong”.

Meanwhile, the question prediction levels are indices indicating percentages in which testees that do not know correct answers correctly answer through prediction. In this case, the question prediction level, which is a minimum limit of the item characteristic curve, and may be generally determined by a y-intercept value of the item characteristic curve. That is, in the example of FIG. 6, a prediction level of Question A is represented as “strong”, a prediction level of Question B is represented as “weak”, and a prediction level of Question C is represented as “weak”.

As described above, referring to FIG. 6, a question having characteristics of “Question B” having a low question difficulty level and a middle question discrimination level may be recommended in the case of a user of which an obtainable score predicted through the system of providing customized learning contents according to an exemplary embodiment of the present disclosure is low, and a question having characteristics of “Question C” having a high question difficulty level and a high question discrimination level may be recommended in the case of a user of which an obtainable score predicted through the system of providing customized learning contents according to an exemplary embodiment of the present disclosure is high.

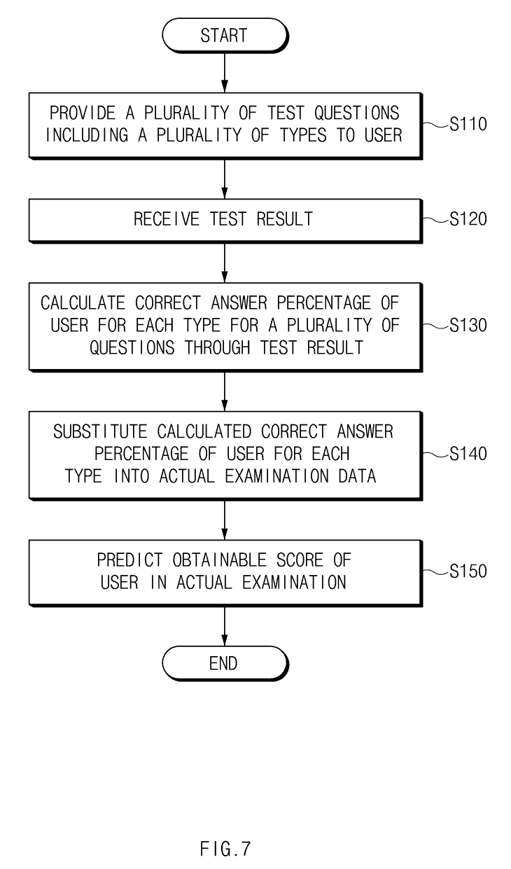

FIG. 7 is a flow chart illustrating a method of providing customized learning contents according to an exemplary embodiment of the present disclosure.

Referring to FIG. 7, the method of providing customized learning contents using a system including a database storing a plurality of test questions including a plurality of types, provided to a user, a test result for the user, and test results for other users according to an exemplary embodiment of the present disclosure may include providing the plurality of test questions including the plurality of types to the user (S110), receiving the test result (S120), calculating a correct answer percentage of the user for each type for the questions through the test result (S130), substituting the correct answer percentage of the user for each type for the questions into actual examination data (S140), and predicting an obtainable score of the user in an actual examination (S150).

In the method of providing customized learning contents according to an exemplary embodiment of the present disclosure, in S110, the plurality of test questions including the plurality of types are provided to the user. In this case, the user inputs answers to the plurality of test questions on the system within a preset limit time. In addition, as described above, the user may select a kind of desired examination on the system to allow test questions for the corresponding examination to be provided.

Then, in S120, the test result is received. In detail, the system determines whether the received answers of the user to the test questions are correct or wrong, and calculates a grade.

In S130, the correct answer percentage of the user for each type for the questions may be calculated through the test result. In this case, as described above, the correct answer percentages of the other users that have used the system of providing customized learning contents in the past as well as the user directly applying for the test, for each question type may be stored in the database or be newly calculated.

As described above, correct answer percentages of the user for the remaining types that the user does not solve as well as types that the user directly solves through test questions may be calculated using the correct answer percentages of the other users for each question type. In this way, correct answer percentages for all types that may be issued in an examination selected by the user that is currently using the system may be calculated.

Meanwhile, in S140, the correct answer percentage of the user for each type for the questions is substituted into the actual examination data. That is, the questions issued in the actual examination are classified for each type, and data on the correct answer percentage of the user for each question type calculated in S130 are input to the classified questions.

Finally, in S150, the obtainable score of the user in the actual examination is predicted. That is, it may be determined whether answers to the respective questions in the actual examination are correct or wrong using the data on the correct answer percentage of the user for each question type calculated in S130, and the obtainable score of the user in the corresponding examination may be finally calculated. In addition, the calculated original score may be substituted into standard distribution data to calculate a standard score.

In addition, the method of providing customized learning contents according to an exemplary embodiment of the present disclosure illustrated in FIG. 7 may further include registering a tag for each question depending on an attribute of the question input to the system and providing contents customized to a learning level of the user. Detailed contents are the same as those described above with reference to FIG. 1, and a detailed description thereof will be omitted.

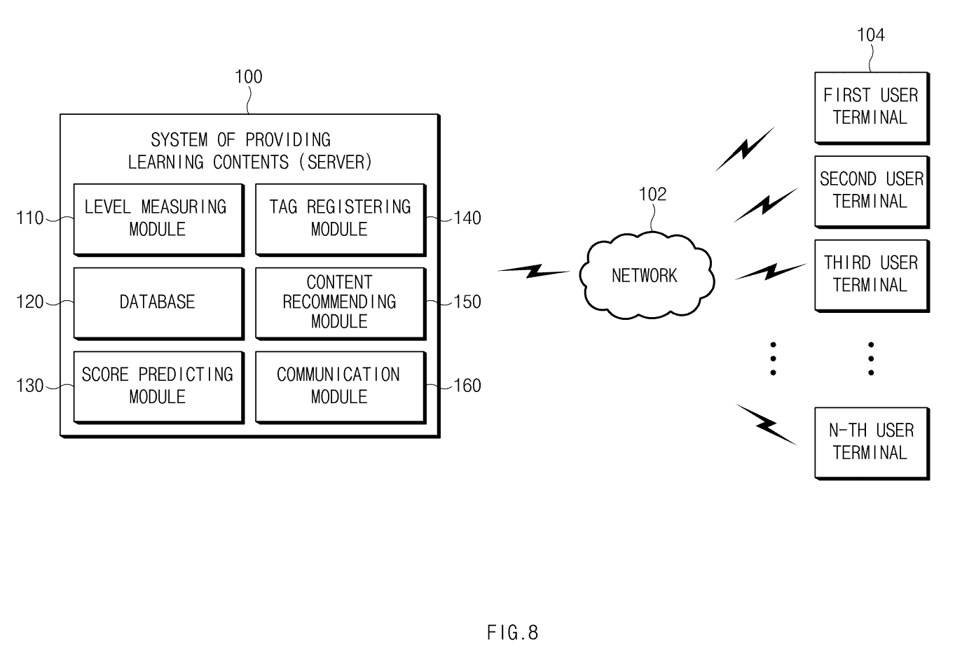

FIG. 8 is a view illustrating that the system of providing customized learning contents according to an exemplary embodiment of the present disclosure and user terminals are connected to each other through a network.

Referring to FIG. 8, the system (server) 100 of providing customized learning contents may further include a communication module 160 for communicating with the user terminals 104 through the network 102. In this case, the user terminals, which are mobile terminals, may include, for example, a smartphone, a tablet, a personal computer (PC), or the like.

First, test questions including a plurality of types (for example, a plurality of tags) stored in the database 120 of the system 100 of providing customized learning contents may be provided to first to N-th user terminals 104. In addition, when users create answers to the test questions through the user terminals 104 and transmit the answers to the system 100 of providing customized learning contents through the network 102, the system 100 of providing customized learning contents may measure current learning levels of the users through test results, and substitute the current learning levels into actual examination data to calculate scores predicted to be obtained by the users in an actual examination. The calculated predicted scores may be provided to the user terminals 104 possessed by the user through the network 102 and be displayed to the users.

In addition, the system 100 of providing customized learning contents may provide recommendation questions appropriate for the users, such as questions of types in which the users are currently weak, questions having a difficulty level appropriate for the current learning levels of the users, questions of types actually issued at a high frequency in past test questions, and the like, to the user terminals 104 through the network 102 on the basis of the measured learning levels of the users. In this case, the users may efficiently perform learning appropriate for the current learning levels of them through the recommendation questions received from the system 100 of providing customized learning contents.

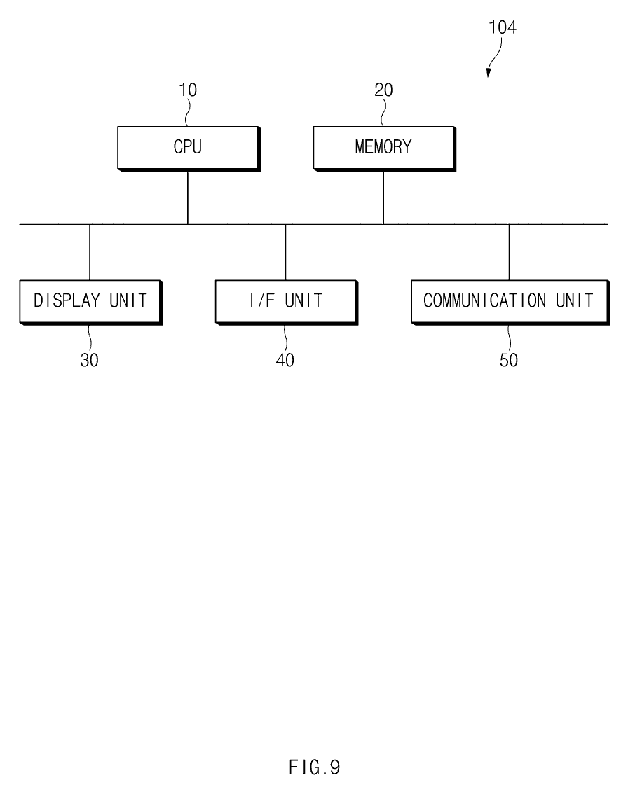

FIG. 9 is a view illustrating a hardware configuration of a user terminal including a learning content application according to an exemplary embodiment of the present disclosure.

Referring to FIG. 9, the user terminal 104 may include a central processing unit (CPU) 10, a memory 20, a display unit 30, an interface (I/F) unit 40, and a communication unit 50.

The CPU 10 serves as execute a learning content application stored in the user terminal 104, and the memory 20 may store the learning content application, test questions and test results, data on a predicted score obtainable by the user, and the like, received from the server.

The display unit 30 may display the test questions, the obtainable score of the user, and the like, received from the server to the user. In addition, the display unit 30 may also receive and display various questions provided for learning after a test. To this end, the CPU 10 may execute the learning content application to allow a graphic user interface (GUI), or the like, to be displayed on the display unit 30, and the user may input a desired instruction through the GUI.

The I/F unit 40 may perform an interface function for an input from the user and an output signal of the user terminal 104. For example, the I/F unit 40 may be an input device such as a touch panel, or the like, and an instruction performed by the user on the basis of the GUI, or the like, displayed on the display unit 30 may be input through the I/F unit 40.

In addition, the communication unit 50 may be connected to the system (server) 100 of providing customized learning contents through the network 102, as described above, to perform communication of various information such as the test questions or questions for learning, the test results, the predicted scores, and the like.

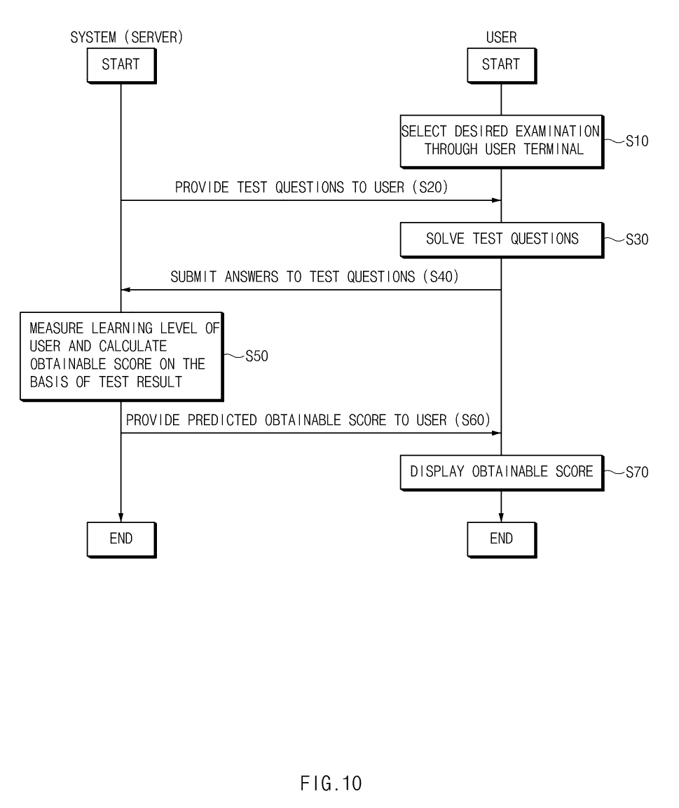

FIG. 10 is a flow chart illustrating a method of performing learning by communication between the system of providing customized learning contents according to an exemplary embodiment of the present disclosure and the user terminal.

First, the user selects a kind and a subject of desired examination through the user terminal 104 (S10). When the user selects the examination, the server 100 transmits test questions stored in the corresponding examination to the user terminal 104 through the network 102 (S20).

When the test questions are received by the user terminal 104, the user starts to solve the test questions (S30). When the solving of the questions by the user is completed, the user submits an answer to the test, and the submitted answer is transmitted to the server 100 through the network 102 (S40).

The server 100 measures the learning level of the user on the basis of the answer submitted by the user. In this case, it may be determined whether answers to tags assigned to each of the test questions are correct or wrong to calculate a correct answer percentage of the user for each tag, thereby diagnosing a learning level of the corresponding user for each tag. Then, the calculated learning level (for example, the correct answer percentage for each tag) of the user is input into the actual examination data selected by the user, and it is determined whether answers to the respective questions are correct or wrong to calculate a final score predicted to be obtained by the user in the corresponding examination (S50). Since a method of measuring the learning level and calculating the obtainable score in S50 is described in detail with reference to FIGS. 1 to 7, and a detailed description thereof will be omitted.

Then, the obtainable score of the user calculated by the server 100 is provided to the user terminal 104 through the network 102 (S60), and the obtainable score is displayed on the user terminal 104 and is stored in the memory 20, such that the obtainable score may be directly confirmed at any time by the user executing the application (S70).

As described above, according to the system and the method of providing customized learning contents according to an exemplary embodiment of the present disclosure, the learning level of the user may be accurately diagnosed and the learning contents optimized for each user may be provided to maximize a learning effect.

Although it has been described that all components configuring the exemplary embodiment of the present disclosure are combined with each other as one component or are combined and operated with each other as one component, the present disclosure is not necessarily limited to the abovementioned exemplary embodiment. That is, all the components may also be selectively combined and operated with each other as one or more components without departing from the scope of the present disclosure.

In addition, hereinabove, the terms “include”, “configure”, “have”, or the like, are to be interpreted to imply the inclusion of other components rather than the exclusion of other components, since they mean that a corresponding component may be included unless particularly described otherwise. Unless defined otherwise, all the terms including technical and scientific terms have the same meaning as meanings generally understood by those skilled in the art to which the present disclosure pertains. Generally used terms such as terms defined in a dictionary should be interpreted as the same meanings as meanings within a context of the related art and should not be interpreted as ideally or excessively formal meanings unless clearly defined in the present disclosure.

The spirit of the present disclosure has been illustratively described hereinabove. It will be appreciated by those skilled in the art that various modifications and alterations may be made without departing from the essential characteristics of the present disclosure. Accordingly, exemplary embodiments disclosed in the present disclosure are not to limit the spirit of the present disclosure, but are to describe the spirit of the present disclosure. The scope of the present disclosure is not limited to these exemplary embodiments. The scope of the present disclosure should be interpreted by the following claims and it should be interpreted that all spirits equivalent to the following claims fall within the scope of the present disclosure.

What is claimed is:

1. A system of providing learning contents, comprising:
a level measuring module providing a plurality of test questions including a plurality of types to a user and receiving a test result;
a database storing the plurality of test questions including the plurality of types, provided to the user, a test result for the user, test results for other users; and
a score predicting module calculating a correct answer percentage of the user for each of the plurality of types through the test result and substituting the correct answer percentage into actual examination data to predict an obtainable score of the user in an actual examination.

2. The system of providing learning contents according to claim 1, further comprising a tag registering module registering a tag for each question depending on an attribute of the question input to the system.

3. The system of providing learning contents according to claim 2, wherein the tag registering module provides recommending tags related to the attribute of the question input to the system, and allows an administrator of the system to select and register desired tags of the recommendation tags.

4. The system of providing learning contents according to claim 2, wherein the score predicting module predicts whether an answer of the user to another question including the same tag as the tag is correct or wrong to predict the obtainable score of the user in the actual examination.

5. The system of providing learning contents according to claim 1, further comprising a content recommending module providing contents appropriate for a learning level of the user.

6. The system of providing learning contents according to claim 5, wherein the content recommending module extracts a sample group having predicted scores following a normal distribution of past test questions among the predicted scores for each user, and determines difficulty levels of the questions through an item characteristic curve generated by testing the same questions as the past test questions in the sample group to provide the questions.

7. The system of providing learning contents according to claim 5, wherein the content recommending module provides expected questions on the basis of one or more of similarity to passages of past test questions, similarity of keywords and types of the past test questions, and whether or not answers coincide with correct answers of the past test questions.

8. The system of providing learning contents according to claim 5, wherein the content recommending module provides questions in which the user is weak on the basis of the learning level of the user.

9. The system of providing learning contents according to claim 8, wherein the questions in which the user is weak are extracted from a plurality of questions including types for which correct answer percentages of the user are a preset reference or less.

10. The system of providing learning contents according to claim 5, wherein the content recommending module provides questions including types for which correct answer percentages of the user are in a preset range of the correct answer percentage using the calculated correct answer percentage.

11. The system of providing learning contents according to claim 5, wherein the content recommending module determines frequencies at which the types are issued in the actual examination, and arranges and provides questions appropriate for the learning level of the user in a descending order of the frequencies.

12. The system of providing learning contents according to claim 1, wherein the level measuring module provides a correct answer percentage of the user for a predetermined number of times for a plurality of questions including a specific type using a skip-gram to update a learning progress situation of the user for each type.

13. The system of providing learning contents according to claim 1, wherein the score predicting module predicts the obtainable score of the user through a deep learning technique.

14. A method of providing learning contents using a system including a database storing a plurality of test questions including a plurality of types, provided to a user, a test result for the user, and test results for other users, comprising:
providing the plurality of test questions including the plurality of types to the user;
receiving the test result;
calculating a correct answer percentage of the user for each of the plurality of types through the test result;
substituting the correct answer percentage of the user for each type for the questions into actual examination data; and
predicting an obtainable score of the user in an actual examination.

15. The method of providing learning contents according to claim 14, further comprising registering a tag for each question depending on an attribute of the question input to the system.

16. The method of providing learning contents according to claim 14, further comprising providing contents appropriate for a learning level of the user.

17. A learning application stored in a user terminal, the learning application executing the following processes:
a process of providing a plurality of test questions including a plurality of types to a user;
a process of transmitting a test result to a server when the user submits answers to the plurality of test questions including the plurality of types; and
a process of receiving and displaying an obtainable score of the user in an actual examination, calculated by the server.

18. The learning application according to claim 17, further executing a process of providing contents appropriate for a learning level of the user.
